(19) United States
(12) Patent Application Publication
(10) Pub. No.: US 2011/0300457 A1
(43) Pub. Date: Dec. 8, 2011

(54) FUEL CELL SYSTEM WITH REOXIDATION BARRIER

(76) Inventors: Sascha Kuehn, Dresden (DE); Katrin Klein, Dresden (DE); Gerhard Buchinger, Wels (AT)

(21) Appl. No.: 12/998,885

(22) PCT Filed: Dec. 14, 2009
(86) PCT No.: PCT/EP2009/008951

§ 371 Date: Aug. 24, 2011

(30) Foreign Application Priority Data
Dec. 12, 2008 (DE) 10 2008 064 025.5

(51) Int. Cl. H01M 8/04; H01M 2/10; H01M 8/06; H01M 2/02

(52) U.S. Cl. 429/410; 429/516; 429/423; 429/408; 429/443; 429/428; 429/429; 429/512

(57) ABSTRACT

A fuel cell system comprising at least one fuel cell unit (1) to generate electrical power and at least one component, upstream and/or downstream of said fuel cell unit in the anode flow path, said component preventing, as a reoxidation barrier, reoxidation of parts of the anode sections or of the anode sections as a whole in the case that an oxidizing gas is entering.

The present invention refers to fuel cell systems, in particular a SOFC system with tubular or microtubular Solid Oxide Fuel Cells (hereinafter called SOFC).

Fuel cell systems with heat transfer device or exchangers are known as state of the art (e.g. EP 1921703). However, substantial heat losses still occur through transfer of the anode and cathode exhaust gases to the surroundings and through the loss due to insufficient insulation. The installation of several heat exchangers or the application of thicker insulation layers are physically practical only to a limited extent and also economically less viable, since it results in a larger volume and significantly higher material and manufacturing costs of said fuel cell systems.

The problem to be solved by this invention is to achieve a higher energy density (energy generation per volume and energy generation per mass) of the fuel cell system and while said fuel cell system due to its embodiment can be operated safely and reliably with a simple and energy-saving control.

Fuel cell system according to claims 1 and 2 can solve this problem. Additional advantageous embodiments of the inventive fuel cell system can be found in the dependant claims.

The individual features of the embodiment are described by way of example and can also be realized independently from another within the scope of the present invention and need not be comprehended precisely in the feature combinations as illustrated by way of the examples.

According to the present invention, the fuel cell system comprises at least one fuel cell unit to generate electrical power and at least a reoxidation barrier. Preferably integrated are also a reformer upstream of the fuel cell unit(s) to generate reformed fuel, an afterburner and a heat exchanger downstream of the fuel cell unit(s) to transfer the heat between the fuel cell exhaust gas and the air supplied to the cathode and/or the fuel supplied to the anode or system components, respectively.

The fuel cell unit can comprise one or preferably several microtubular fuel cells or fuel cell units (stacks). The microtubular cells have a cell diameter of 0.1 mm to 5 cm and a length of 1-40 cm, whereby said fuel cell can be enclosed by a likewise round or a square heat exchanger and therefore the heat exchanger can be wrapped around said fuel cells or fuel cell stacks. The heat transfer between said heat exchanger and the system components fuel cell unit, reformer and burner is realized via convection and/or thermal radiation and/or thermal conduction.

According to the present invention, the system comprises equipment which allows for a safe and reliable operation without an expensive, energy-intensive and possibly space-consuming control system.

Within the scope of the present invention this is realized by means of a reoxidation barrier. This device prevents or reduces—at least temporarily—the potential reoxidation of the anode material or other system components downstream of the reoxidation barrier, which otherwise can damage the cell.

Preferably, this safety device (reoxidation barrier) is installed upstream of said fuel cell unit(s), preferably between the reformer and the fuel cell unit(s). Alternatively or as addition, said reoxidation barrier can also be installed downstream of the fuel cell unit(s).

Said components can be constructed and/or comprise at least in part, of fine nickel powder and/or carbon powder and/or iron powder and/or copper powder. In terms of the present invention, other oxidisable compounds or metals can also be utilised as reoxidation barriers, if they are stable within a temperature range of approximately 50-1000° C., preferably 500-850° C., and under the typical reducing atmospheres of the fuel cell anodes or the peripheral components of the gas flow. Examples are wolfram, cobalt, aluminium, silicon and, where required, alkali and alkaline earth metals. The reoxidation barrier is oxidised by an inflowing oxidizer (e.g. oxygen from the air) and thus, prevents the oxidation of the anode and therefore prevents damage to the cell. In the case of again inflowing reducing gas the reoxidation barrier is repeatedly reduced and due this it can act again as safety device (except for carbon, which will be burned off to CO/CO2). A very large specific surface (>1 m²/g-200 m²/g) of the barrier material is preferred. The barrier material can be powder, by the way of example placed as packed bed between perforated metal plates. By correspondingly selecting the right particle diameter or the form of the packed bed components, a system-compatible flow resistance can be adjusted. A further option of embodiment is the coating of the inlet pipe(s) and if necessary the heat exchanger with said barrier material or the insertion of highly porous foam made of said material or an inert substrate, which is coated with said material. In terms of the present invention, also monoliths and other geometric forms can be used as barriers.

Other alternative reoxidation barriers are meshes of inert substrates coated with the reactive material or meshes made of said reactive material. The meshes can be made of wire with thickness of 1 μm to 1 mm and a mesh size of up to 400 mesh. Particular suitable are meshes made of metals, such nickel or copper. Common coating methods such as dip-coating, sputtering, precipitation, spraying, electrochemical deposition, impregnation or electrophoretic deposition can be used. A layer with a large specific surface is ideal. A large surface and/or a high temperature guarantee that the reoxidation barrier, having the same material combination as the anodes of the fuel cell, exhibits a higher reactivity with oxygen than said anodes.

An additional preferred variant is that the reoxidation barriers are fuel cells whereby said fuel cells are integrated as sacrificial fuel cells into the system. Based on that, the fuel cells can, under normal conditions, contribute to the production of electrical power. Should oxidizers enter the anode side accidentally (e.g. temporary excess of air due to controlling error of the reformer), the anodes (e.g. made of nickel cermet), of said sacrificial cells are oxidized and therefore can be damaged.

The advantage of this embodiment is that in an ideal scenario, and through the contribution of said sacrificial cells, the service life and/or the efficiency of said system can be increased and only in an accidental case when air is inflowing this positive effect is not ensured.

The system can be fitted with sensors that will detect a critical condition of said system and shut down said system before the (remaining) fuel cells are damaged. By way of example, this procedure can be realized by quickly cooling down said system by reducing the inflow of fuel to the anode and increasing the air supply to the cathode. These reoxidation barriers can be combined with check valves in particular at the exit thus, providing a safety mechanism for said system.

As one possible aspect of the present invention, a so-called soot trap can be used as alternative or in addition. The task of the soot traps is keeping chemical compounds away from the fuel cell anode, whereby said compounds have a high tendency to lead to carbon deposition, such as ethylene or aromatic compounds, and said compounds can be present in the fuel and/or can be present in small concentrations due to insufficient reformation downstream of the fuel reformer. This can be particularly pronounced in non quasi-stationary operating modes such as the start-up and shut-down phase. In this case, said components react at the location of the soot trap to form carbon.

The soot trap is designed in a manner that the deposited carbon does not lead to blocking the path of the anode gas. This can be realized by an appropriately large flow cross section (e.g. larger than 1 mm) in said soot trap or the selective installation of flow channels inside the soot trap, whereby said flow channels are not coated with material having a high tendency of carbon deposition and/or are not made of such material. The installation of additional chambers to collect the deposited soot and whereby said soot traps can be emptied or are exchangeable is also possible within the scope of the present invention.

In the simplest case, the soot trap can comprise the active material of the fuel cell anode. In order to realise a very high soot generating activity, the temperature of the soot trap can be different (e.g. 10-500° C. colder) compared to the operating temperature of the fuel cells. By way of example, a soot trap made of nickel is mentioned here. Said soot trap by the way of example can comprise a packed bed consisting of fine nickel powder (e.g. with a specific surface of 10-200 m²/g) and can be kept at a temperature of 500-1100° C. at quasi steady operation while the fuel cell is operating at a working temperature of 700-900° C. During the start-up and shut-down mode said soot trap is preferably operated between room temperature and 1100° C.

Alternatively, ceramic materials such as Al2O3 in form of foam or monoliths can be utilised, whereby said foam or monoliths preferably are coated.

The required temperatures depend thereby on the used hydrocarbons and the ratio of oxygen/carbon and/or of the steam/carbon and/or the carbon dioxide/carbon ratio.

Regeneration of the soot trap can be achieved by simple combustion of the deposited carbon whereby oxygen and/or water vapour and/or other oxidising components are deliberately fed to the said soot trap, causing carbon to oxidise (burn off) and to exit the system as gaseous product (e.g. CO, CO2). To do this, a selective Regeneration of the soot trap can take place without damaging the components of the fuel cell system. This can be realised by using a process during which the soot trap for kinetic and/or thermodynamic reasons displays another temperature than the fuel cell unit(s). The temperature can be adjusted by external heating elements (e.g. additional burners or electrical heaters) or preferably by realizing an appropriate system construction. By way of example, in the latter case the fuel cell units for higher temperatures can be located closer to the reformer and/or afterburner or vice versa. To protect the fuel cells, a bypass valve (e.g. 3-way valve) can also be integrated in the system, whereby said valve causes for example gases with high oxygen content that are supplied to the soot trap and/or reformer for Regeneration reasons, not to enter the fuel cell units but said gases exit the system via flushing pipes.

Alternatively, the fuel cell can be kept below a critical temperature. Said temperature depends on the exposure time and type of oxidizer and the anodes used (e.g. if nickel is utilised, air up to a temperature of 250° C. can be used without any significant oxidation occurring). This can be achieved if the fuel cells are kept at room temperature or a low temperature (up to approx. 300° C.) and the soot trap is heated to 300-900° C. by means of an external burner or an electrical heater. An increased soot trap temperature can also be realised whereby the reformer is heated by means of an exothermal reaction (e.g. partial and/or total oxidation of hydrocarbon and, if necessary, operated with surplus oxidizer such as air or water vapour) and said reformer is preferably located within close proximity of said soot trap and whereby the hot exhaust gases of the reformer with a high concentration of water vapour, carbon dioxide and if necessary oxygen cause the combustion of the soot inside of said soot trap. By way of example, a lower temperature of said fuel cell unit can be realised by means of appropriate system construction (e.g. distance to reformer) and/or by means of increased supply of cathode air for the cooling of said fuel cell unit. Said increased supply of cathode air can be realised, if necessary, by means of electrically or mechanically (e.g. also supported by the system's exhaust flow) operating pumps and/or fans and/or by means of a venturi nozzle and/or jet pump whereby said nozzle and pump are controlled e.g. by a valve.

Alternatively or as addition, the amount of air can be limited whereby said air reacts primarily only with the soot and whereby said air does not reach the anode. Increased air supply can also be pulsed into the fuel channel in order to reduce the soot deposits in the system. Another alternative exists whereby the reformer is operated temporarily with increased oxygen/carbon and/or increased water vapour/carbon ration and/or CO2/carbon ratio.

For a stable operation, in particular during the start-up and shut-down phase, the following procedure can be applied. By using the appropriate approach, the reoxidation barrier is selectively reoxidised during the cooling-off phase of the system without damaging the fuel cell units (e.g. guaranteed by the fact that the cells are protected by methods described in the preceding explanation regarding the regeneration of the soot trap). During the following heating phase of the system the barrier is again reduced, whereby water and/or carbon monoxide and/or carbon dioxide are released, which in turn leads to a more stable operation of the fuel cell unit during said heating phase.

Especially preferred is a process whereby the fuel cell units during the system's heating and cooling-down phase and according to a beneficial approach, exhibit a lower temperature than the reoxidation barriers, whereby said barrier exhibits a higher reactivity with the oxidizer, e.g. oxygen from the air or water vapour, even if the same or similar material combinations are used as in the anode segment of the fuel cell units. Based on the higher temperatures, a higher reactivity is realized, i.e. the fuel cell cools down faster during the system's shut-down phase (cooling-off phase) than the reoxidation barrier and subsequently oxygen or air is passed through the hot (200-900° C.) reoxidation barrier. Also during the heating phase of the oxidised reoxidation barrier, said barrier can be reduced with a higher temperature (200-900° C.) than the fuel cells have at the same time and a reducing gas (e.g. fuel) and thereby water and carbon dioxide can be generated.

Especially preferred is a fuel cell system comprising microtubular SOFCs, as said SOFCs exhibit a very high thermal shock resistance. Advantageously, the tubular or microtubular SOFCs can function as inner burner in order to generate the fuel cell system's heat. This outstanding feature allows a respective fast adjustment of the desired temperature profile of the system. As mentioned above, if necessary, the fuel cells can be cooled off quickly by using the surplus of air from the cathode segment. Additionally, it is preferred that the reoxidation barrier is spatially closer to the burner, so that said reoxidation barrier exhibits a temperature 50-800° C. hotter than the fuel cell units.

As a preferred system variant, separate mixing units, in particular upstream of the reformer and/or the afterburner can be utilised, to mix oxidisable and reducible chemical compounds.

As an additional safety measure the present invention prefers to integrate into the system a device upstream of the reformer for the removal of system-damaging components (contamination of the anode or the catalyst, appearances of corrosion, etc.), whereby said components derive from unreformed fuel. The removal of potentially damaging compounds, which basically can be composed with elements of the periodic table's groups IA-VIIA and IIB (e.g. from sulphur components, halogen compounds, phosphor compounds), occurs preferably by means of adsorption (e.g. based on zinc oxide, activated carbon (if necessary activated with additives) or with commercially available adsorbing materials) and whereby said adsorption preferably occurs at room temperature (e.g. activated carbon). Mostly said cell-damaging components (fuel contamination) are found in the fuel only in small concentrations (1 ppb-10000 ppm). For this reason and depending on the service product life, and depending on the dimensions of the adsorption device, replacements are not required or extremely rare.

In order to realise compact system dimensions and/or to minimise thermal losses, electric power which is generated in the fuel cell units, is preferably tapped from the heat exchanger(s) integrated into the system. On one hand this enables the use of a compact design as well as savings in material and production costs, and on the other hand prevents or at least reduces heat loss due to thermal bridges, caused by separate electrical contacts.

The heat exchanger intended for the heat transfer between fuel cell exhaust gas and the air supplied to the cathode and/or the fuel supplied to the anode and/or the reformable fluid mixture supplied to the reformer, can be located in the immediate proximity of the fuel cell unit(s) and/or said heat exchanger (6) can be arranged enclosing and/or surrounding the said fuel cell unit(s) at least in sections, but preferably in its entirety, and/or said heat exchanger can enclose and/or surround said reformer and/or afterburner of said fuel cell system.

Advantageously, the fuel cell system of the present invention comprises one or several fuel cell unit(s), one or several serial-connected jet pumps and/or venturi nozzles which are used to ingest air through the inflowing pressurized fuel and for pre-mixing the fuel with the air upstream of the reformer, a reformer with an ignition device, a burner and catalyst, as well as one or several serial-connected jet pumps and/or venturi nozzles downstream of the fuel cell unit for mixing the anode exhaust gas with air, in particular the cathode exhaust air, and for transferring the anode exhaust gas/air mixture to the afterburner, an afterburner consist of a burner and a catalyst for the conversion of the anode exhaust gas/air mixture to exhaust gas, whereby the exhaust gas is guided through a heat exchanging device and thereby the heat of the exhaust gas is utilised to pre-heat the cathode supply air and simultaneously the exhaust gas is cooled.

Advantageously, the embodiment of the heat exchanger surrounds the fuel cell unit, whereby the waste heat of said fuel cell unit is absorbed, amongst other things, by the cathode air flowing into the system. Furthermore, the supply media (e.g. inflow of supply air as well as inflow of fuel) can be turned on or off by means of valves or can be controlled in at least zero steps. For the supply control of the fuel and for the supply control of the air, said valves can be operated mechanically and/or electrically and/or pneumatically and/or hydraulically and/or electromechanically. In particular, feedback with the system's control or safety functions can be provided. By way of example, said safety functions can be provided by integrating sensors (e.g. pressure, temperature, concentration sensors) into the system.

In a preferred variant, precautions must be provided in all system locations where mixtures of oxidizable and reducible gases occur at temperatures above the ignition temperature of said mixture and where the ignition of said mixture is undesirable. This can be guaranteed by selecting a small flow cross section of one or several pipes in order to prevent flashback. A typical flow cross section would be 1 μm-10 mm, preferably between 10 μm-500 μm.

The preferred variant of the present invention is a fuel cell system with a continuous power rating lower than 500 W and more preferred is a power rating lower than 100 W.

A further idea of the present invention is to utilise jet pumps and/or venturi nozzles and/or coanda nozzles for the fuel and/or air supply or for the removal of exhaust gas. When compared with other types of pumps, the use of jet pumps and/or venturi nozzles has the particular advantage that said pumps and/or nozzles do not comprise moving parts and are therefore wear-resistant and allow a compact embodiment. Said jet pumps and/or venturi nozzles have a passive design, that is to say, they permit a flexible gas and/or fluid supply or gas and/or fluid removal of the fuel cell system without (permanent) external energy supply.

The preceding problem is solved by the present invention of the fuel cell system in combination with a reoxidation barrier and especially advantageously due to the compact design through the combination of the heat exchanger's in the immediate proximity of the fuel cell unit, whereby said heat exchanger actively maintains the heat on the fuel cell unit, also through the use of a compact design of the jet pumps, trough the use of valves for the fuel and air supply and through the use of an afterburner, whereby said afterburner is suitable for converting fuel that was not converted in the fuel cell.

By arranging the heat exchanger around the fuel cell unit, it is possible to preheat the cathode supply air inside the cathode air inlet pipe and simultaneously cool the exhaust gas flowing via the exhaust gas pipe into the heat exchanger, whereby the waste heat losses to the surroundings via the exhaust heat pipe are kept at a minimum. Overall, this embodiment increases the efficiency of the fuel cell system and/or reduces the temperature of the exhaust gas in the system's surroundings.

The use of jet pumps allows the conveyance of supply air or exhaust gas without the use of fans or other type of pumps with moving parts, which in turn leads to a compact design and which can lead to a higher energy yield per volume and per mass. But also the utilisation of fans, pumps, blowers and, if necessary, the support of the venturi nozzles/jet pumps by said fans, pumps, blowers is within the scope of the present invention.

With the application of preferably controllable valves for the fuel and supply air it is possible—in particular in the case of venturi nozzles/jet pumps—to provide fuel as well as supply air depending on the demand of the fuel cell unit, which allows adjustment to the respective performance requirement which in turn also leads to fuel reductions in case of low loads and an improved energy yield. Furthermore, in case of a shut-down of the reformer the valves can prevent the flow of air into the area of the anodes as long as the fuel cell unit is still hot and thus the valves also prevent damage to the fuel cell unit through reoxidation.

The afterburner installed between the exit of the jet pump(s) downstream of the fuel cell unit, and preferably the beginning of the exhaust gas pipe leading to the heat exchanger, allows for converting the fuel which was not converted inside the fuel cell unit and thus contributes to improving the energy yield of the fuel cell system and reduces the concentration of flammable gases in the exhaust gas of the system.

Especially preferred is a fuel cell system according to the preceding description whereby wear parts, that is to say, components that tend to have a shorter service life than the overall system, are exchangeable. Said wear parts can comprise: the entire or parts of the fuel cell unit, reformer, afterburner, reoxidation barrier or soot trap. The exchange of said parts can be realized whereby the insulation surrounding the system is fitted with a screw cap and the inserted system can be pulled out. Said wear parts are fitted with detachable clamps and plug-in connections and can be removed, exchanged or integrated again into the system.

Another preferred embodiment of the system comprises several components of the fuel cell system constructed of ceramic parts, preferably injection moulded parts. Most preferred is the design of several components or at least the substrates of the components by using injection moulding. Said substrates can be coated using common ceramic and/or chemical processes such as precipitation, sputtering, spraying, electrophoretic deposition, dipping, plasma coating and electrochemical deposition. One example of the embodiment is to injection mould the substrate of the reformer, the afterburner and the inner electrodes of a microtubular SOFC together. The use of dissimilar materials for the respective substrates is also possible within the scope of the present invention, whereby the so-called moulding tool is sequentially filled with different materials. By selecting the appropriate tool geometry, the flexible design of the forms is also possible. After the moulding process and after sintering, if necessary an electrolyte and the outer electrode can be applied on the inner electrode of the fuel cell (e.g. by spraying, dipping, etc.).

If necessary, the substrates of the afterburner and the reformer can be sealed gas-tight to the surroundings. By way of example, this can be realised with ceramic adhesives or by means of the process which is also applied for the deposition of the electrolytes of the fuel cells. It must be observed that said gas-tight seal is not applied to areas where gaseous communication with another atmosphere (e.g. air) is required. This can be achieved whereby said areas are not coated or subsequently said areas are opened by means of chemical (e.g. etching) or mechanical (e.g. drilling) processes. The substrates of the components can then be coated with active materials. By way of example, the zirconium oxide substrate of the after-burner or reformer can be coated with noble metals by means of impregnation, spraying, dipping and other common ceramic processes. Alternatively, the reformer as well as the anodes of the fuel cells can be made of Ni/YSZ (if required, with added noble metals, Cu, etc.), which makes subsequent coating of the reformer's substrate unnecessary. If several components are moulded together, this is later recognisable in that features of joining processes are not visible.

The preferred variant of the system is characterized in that the system's exhaust gas in particular, but not exclusively, prior to it's entering the heat exchanger, and/or the possibly pressurized fuel can be utilised to drive peripheral equipment such as pumps or fans which are used for the supply of air. This utilisation can be realised by using the physical (e.g. kinetic) or chemical energy remaining in the medium. By way of example, turbochargers, micro gas turbines and/or Peltier elements can be used.

A preferred design of the system, in particular in form of small portable/mobile designs for the provision of electrical power (e.g. as charging device), is a hybrid system with accumulators and/or capacitors. Preferably, common (commercially available) accumulators, e.g. NiCd, NiMH or Li ion accumulators can be used. Said accumulators are located in the cold area of the system, that is to say, thermally insulated from the hot components such as the fuel cell unit, oxidation barrier, soot trap and burner.

A charge controller and, if necessary, a voltage converter can be installed between fuel cell unit and accumulators. Preferably, in this case, the accumulators provide a fast and direct power supply. The fuel cells will only be used to generate power after a certain charge condition is reached (between 1-99%, preferably 30-50%) and/or after a certain duration of current drainage. The electrical power of the fuel cell can then immediately be used by an external power consuming device (which promises a higher efficiency) or to recharge the accumulators and/or capacitors. The respective control function can be achieved via an electronic control unit (e.g. charge controller). By way of example, the required voltage for charging the accumulators or for the external power consuming device can be guaranteed whereby either several fuel cells are connected in series or a voltage converter is applied and thereby the delivered voltage is higher than the required charge voltage or the rated voltage for the external loads. Depending on the type of accumulator, a charge of constant voltage (V), constant current (I), constant wattage (W) or other charging methods can be used, in particular combination of this types and pulse charge processes. The charge voltage for the accumulator or the voltage range respectively, depends on the accumulator type used (Li ions approx. 3-4 V, Pb accumulator approx. 2 V, and multiples thereof, depending on the serial connection). As already said a hybrid system comprising capacitors and/or super capacitors is also possible.

By way of example, the system can be started by heating up the reformer and/or the fuel cell unit and/or the afterburner to a working temperature at which ongoing reactions lead to a further increase of the operating temperature. This can be done through external heat sources, e.g. electrical heater elements (in this case the required power can be provided by the accumulators of the hybrid system) or additional burners.

A further embodiment comprises the installation of an ignition element which causes the start of the reaction inside the afterburner or reformer, which in turn again causes the system's temperature to rise up to the operating temperature. Said ignition devices can comprise an electrically heated element (e.g. wires or wire mesh) or a piezo igniter. A mechanical ignition device, which generates sparks by way of a mechanical movement (e.g. caused by the manual activation or based on the kinematic energy of the gas flowing in the system), is also in the scoop of the invention.

Alternatively, fuels can be used which in combination with catalysts (e.g. noble metals such as Pt, Pd, Rh, etc) exhibit a low ignition temperature (e.g. room temperature up to 500° C.). By way of example, in presence of a noble metal, hydrogen can ignite even at room temperature.

According to the present invention, the system can also be designed, whereby at the start-up phase a mixture of fuel and oxidizer (e.g. air) is not moved across all system components but by way of example, said mixture is only moved into the afterburner or into the reformer using some bypass pipes.

Different fuel to air ratios at the start-up phase as compared with the normal operating condition or during the shut-down mode are also possible. By way of example, the oxygen to carbon ratio can be set higher at the start-up phase, which will lead to a more complete combustion inside the reformer, and as a result increases the heat production. An increased fuel and/or air flow at the start-up phase will also promote heating the system to its operating temperature. In addition, the fuel cell(s) and/or other system components can be heated during the start-up phase, whereby electrical current is passed through said components and the ohmic losses causing an increase in heat. In case of a hybrid system, said current can be extracted from buffer batteries integrated in the system. By way of example, the system can be cooled off by means of reducing the fuel and/or increasing the air supply and/or interrupting the power supply from the fuel cells. In case of the latter method, waste heat of the cells—caused by the electrochemical reaction and the associated losses (thermodynamic, ohmic losses, activation losses, etc.) is not produced any more.

In a preferred embodiment of the system, said system is built of modules, which can be integrated into the respective housing of the system. By way of example, the entire electronic system can be assembled externally onto the module, similar to the HOT BOX. Said modules are integrated into the system housing and subsequently the electrical contacts are connected.

Additional important features and advantages of the present invention can be found in the sub-claims, on the drawings, and associated sketches.

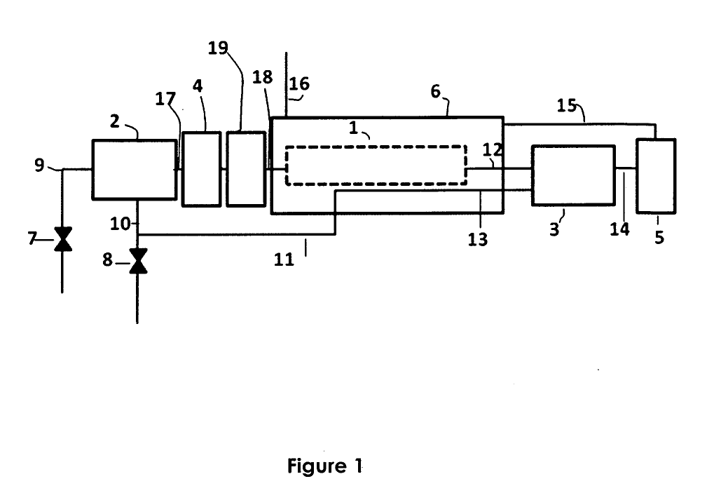

Based on the following FIGS. 1 through 14, examples of the invention's embodiment are described whereby the respective reference signs refer to the design elements:

FIG. 1:

FIG. 1 shows the schematic circuit diagram of the fuel cell system's principle. Main component of the fuel cell system is the fuel cell unit (1) which generates electric current from air and fuel, together with the upstream reoxidation barrier (19), which in case of oxygen entering said barrier is oxidized or binds the oxygen by means of another method such as—but not exclusively—adsorption, whereby the fuel cell unit is protected. The fuel cells are solid oxide fuel cells (SOFC). In order to generate electrical current, the fuel cell is supplied with air via the cathode air supply pipe (11) and with reformed fuel via the reformate supply pipe (18).

Said reformed fuel is obtained from the fuel and air mixture generated by the jet pump (2) inside said reformer (4) that can comprise an ignition device and a catalyst (within the scope of the present invention, a simple thermal reformation without catalyst is also possible). Said mixture is supplied to said reformer via supply pipe (17). The pressurised fuel is supplied to the jet pump (2) via the fuel pipe (9) and serves also to draw air in via air inlet pipe (10). Said fuel supply pipe, as well as said air inlet pipe, is controllable via valves (7), (8). If necessary, fuel can also be drawn in via compressed air. Said valves can control the power output and/or the heat production of the system.

An additional jet pump (3) is installed at the exit of the fuel cell unit, whereby said jet pump is used to mix the anode exhaust gases from the anode exhaust gas pipe (12) with the cathode exhaust air from the cathode exhaust air pipe (13) as well as conducting the anode gas/ air mixture to the afterburner (5). (14) is the pipe leading from the jet pump (3) to the afterburner (5). Said anode exhaust gas/air mixture is converted to exhaust gas inside said afterburner (5) and whereby said exhaust gas is supplied to the heat exchanger (6) via the exhaust gas inlet (15). Instead of one burner (5) a multi-stage burner system can also be used, whereby said burner system is designed to work in an optimised way with the various concentrations of reacting agents and different heat productions at the different burners in the multi-stage system. This method in particular allows the use of one burner for the thermal production and one burner for the removal of carbon monoxide residue.

The heat exchanger (6) encloses the fuel cell unit and allows the heat transfer from exhaust gas to cathode air, so that the cathode air is heated and simultaneously the exhaust gas is cooled off, so that said exhaust gas can be exhausted via the exhaust gas pipe (16) into the atmosphere causing small waste heat losses. Additionally or alternatively to the fuel cell(s), the partial or complete encasing of the reformer and/or burner by the heat exchanger or the installation of said heat exchanger in the immediate proximity of said reformer and/or burner is also possible. Heating of pipe (9) and/or venturi nozzle/jet pump (2) for the generation of increased flow of the medium inside pipe (9) by increasing the (gas) pressure of said medium and thus, an increased suction effect in (2) can also be realized within the scope of the present invention. By way of example, said increase of heat can be caused by electrical means and/or by means of a separate heat exchanger, utilizing the exhaust gas (16) at lower temperatures and/or by means of the heat exchanger (6). In the preferred embodiment, in particular if the fuel consists of pressurized liquid gas, the fuel tank or the fuel pipes (9) are heated in order to generate a constant and/or increased pressure and thus, increased flow rates. This increase of heat can be realised preferably, but not exclusively, by utilizing the system's heat (exhaust gas, radiant heat, heat conduction by the system components, convection of fluids) or by means of heating elements (e.g. electric heater).

As described above, the fuel cell units (1) are tubular SOFCs or microtubular SOFCs, which can function as internal burners.

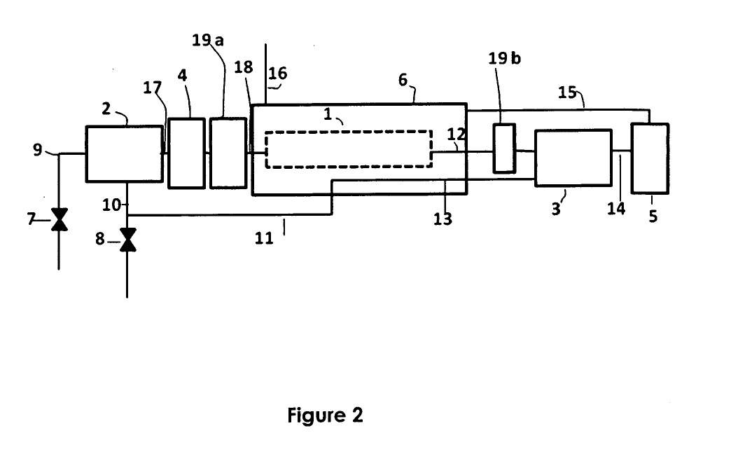

FIG. 2:

A fuel cell system analogue to FIG. 1, comprising a reoxidation barrier (19a) upstream of fuel cell unit (1) and a reoxidation barrier (19b) downstream of the fuel cell unit (1), whereby said fuel cell unit (1) is protected upstream and downstream from reoxidation at least temporarily or preferably completely protected in combination with shut-off valves.

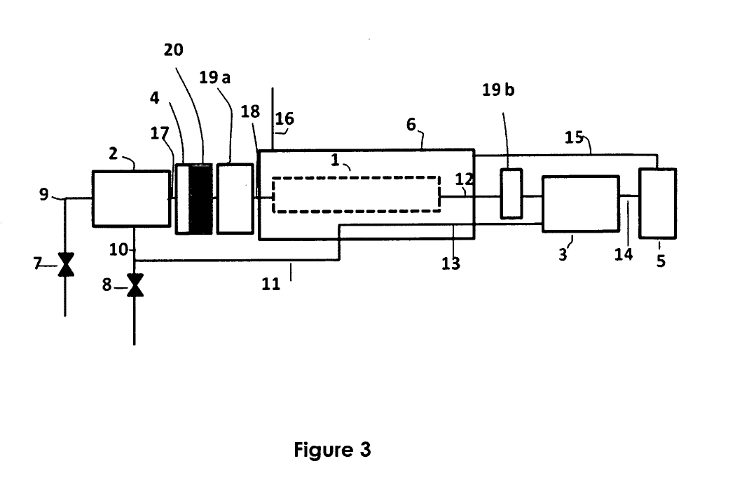

FIG. 3:

A fuel cell system analogue to FIG. 2 comprising additional soot traps (20) that prevent the generation of soot inside the fuel cell unit (1), in particular—but not exclusively—if the reformer (4) does not completely reform the supplied fuel during the system's heat-up and/or cool-off phase and by way of example, components with a high soot forming activity such as ethylene are released from the reformer in concentrations hazardous to the fuel cell unit (1) and/or the reoxidation barrier (19a).

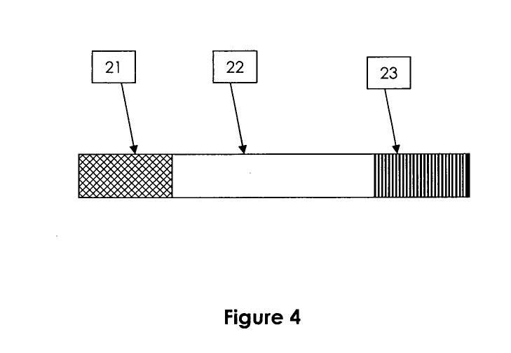

FIG. 4:

According to the present invention, reformers (21), fuel cells (22) and afterburners (23) are injection moulded together, whereby according to the present invention, also just only parts of the individual components can be injection moulded together, as by way of example—but not exclusively—the substrate of the active material of the reformer (21), the substrate of the microtubular SOFC (22) and the substrate for the catalytic acting component of the porous burner (23)

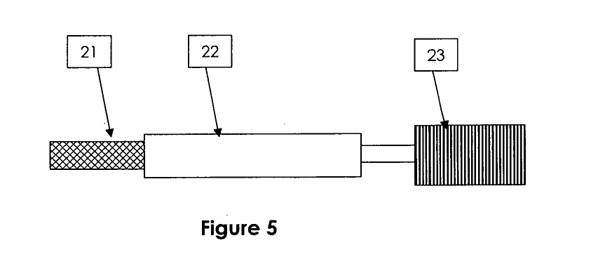

FIG. 5:

Components analogue FIG. 4, whereby components (21), (22) and (23) exhibit different shape and in addition the fuel cell substrate (22) itself consists of different shapes/dimensions.

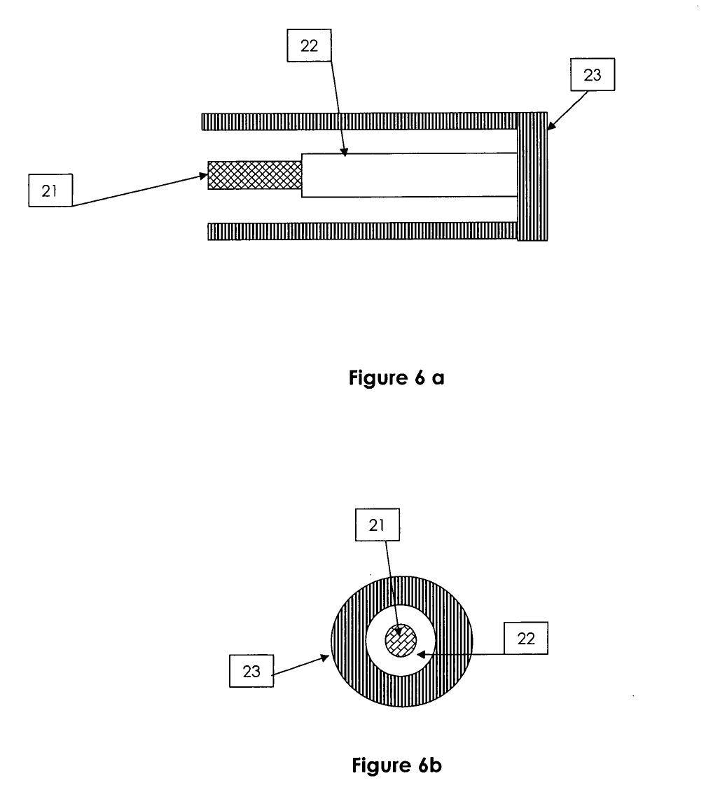

FIG. 6:

FIG. 6a shows the schematic longitudinal section and FIG. 6b shows the cross section of components (21), (22) and (23), which have been built together by means of injection moulding, whereby in this particular shape the afterburner (23) encloses the fuel cell unit (22) and the reformer (21), so that the heat generated in the afterburner (23) is directly transferred onto the fuel cell unit (22) and the reformer (21) and, if necessary, vice versa.

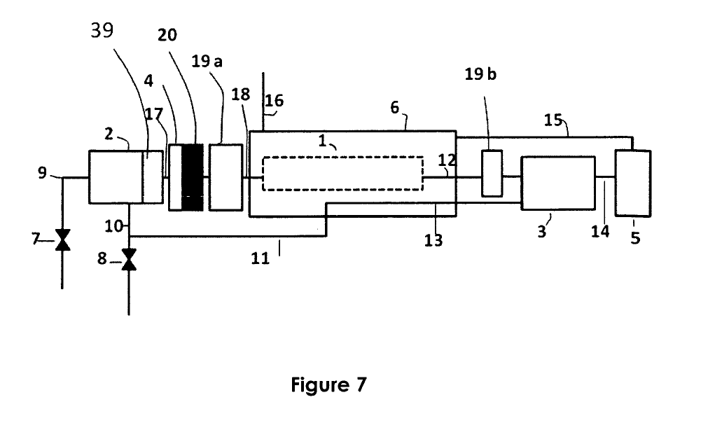

FIG. 7:

Fuel cell system analogue FIG. 3 comprising an additional device (39) for the removal of fuel impurities (e.g. sulphur compounds), which can lead to the reduction of service life due to the degradation of system components such as reformer (4) or fuel cell units (1). Said devices (39) can be integrated into the system at various locations upstream or downstream of the fuel cell unit (1), whereby preferably the installation takes place in supply pipe (9) or directly downstream of the supply pipe (9), prior to adding a second medium to the fuel and before the flow volume is increased and a the contamination concentration is reduced.

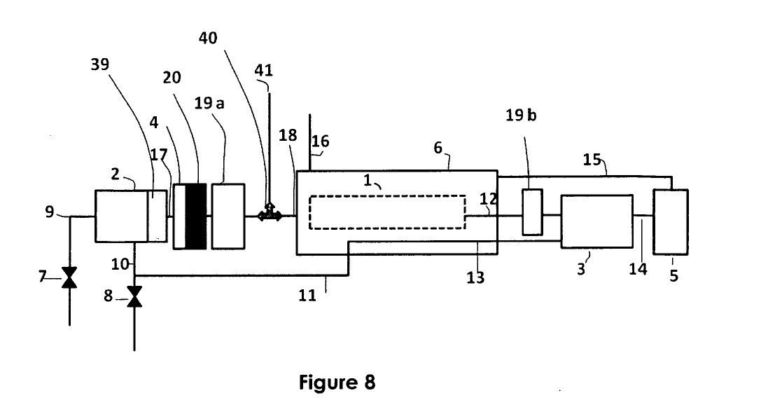

FIG. 8:

Fuel cell system analogue FIG. 7 comprising an additional 3-way valve (40) which, if necessary, in case of a regeneration of the soot trap (20) does not pass the oxygen- or water vapour-enriched gas during the regeneration mode of reformer (4) and/or soot trap (20) and/or reoxidation barrier (19a) and/or contaminated gas in case of regeneration of the device (39) across the fuel cell units (1) but discharges it via pipe (41) out of the system. Within the scope of the present invention, the installation of separate bypasses downstream of the reformer (4) and/or the reoxidation barrier (19a) and/or the soot trap (20) and/or the device (39) for the removal of fuel contaminants and/or the exhaust gas purging through the heat exchanger (6) is possible. Alternatively, pipe(s) (41) can be connected to the after-burner (5). This is preferred if during the regeneration mode of one or several of the afore-mentioned components still combustible components are contained in the gas and a direct discharge in the surroundings of the system is not possible due to safety issues or health concerns.

In such case of course a check valve between afterburner and fuel cell would be preferred to be installed.

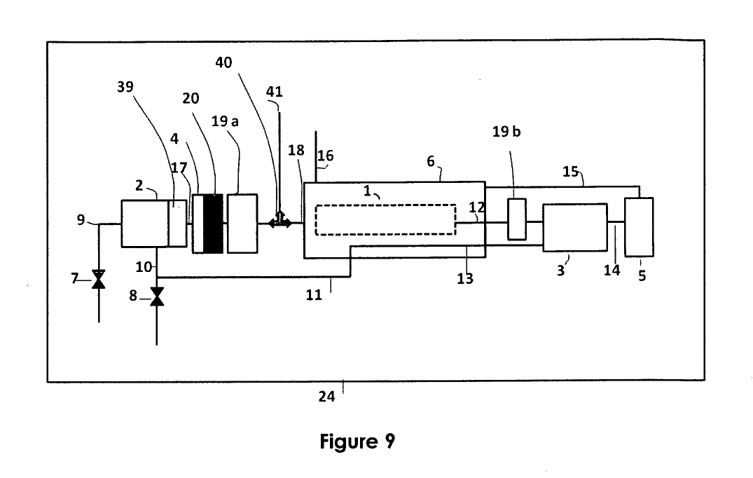

FIG. 9:

Fuel cell system analogue FIG. 8 comprising thermal insulation (24), so that heat losses are kept as small as possible and the system exhibits an outside temperature as small as possible, preferably below 50° C. Said insulation (24) can consist of several layers and can be made of dissimilar materials. Said materials can be plastics and/or ceramic materials with low thermal conductivity values, whereby said insulation can be available commercially and in many designs (aerogel, zirconium oxide fibre, etc.).

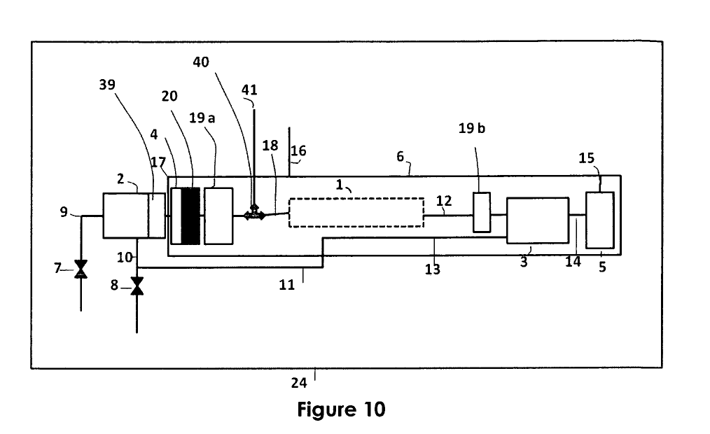

FIG. 10:

Fuel cell system analogue FIG. 9, whereby the heat exchanger (6) encloses not only the fuel cell unit (1), but also the reformer (4), the upstream reoxidation barrier (19a), the downstream reoxidation barrier (19b), the after burner (5), the 3-way valve (40) and the soot trap (20). Within the scope of the present invention, the heat exchanger (6) need not to enclose or can only partially enclose one or several of afore-mentioned system components. Especially preferred is an embodiment whereby at least one of the components such as the reformer (4) and/or the after-burner (5) and/or the device for the removal of contaminants (39) and/or reoxidation barrier (19) and/or the soot trap (20) are integrated into the heat exchanger (6). Such embodiment preferably integrates said active components as coating and/or packed bed and/or foam and/or monoliths into one of the flow channels of the heat exchanger (e.g. supply of cathode air, exhaust of overall system's gases and supply of anode gases). The respective chemical reaction occurs on said coating, packed beds, foams, monoliths (e.g. reforming reaction, afterburning, adsorption, etc.), which causes the transfer or absorption of heat. In another flow channel of the heat exchanger the heat is absorbed or transmitted, whereby said heat exchanger communicates in thermal and if necessary also in limited gaseous terms (1-99%, preferably 10-50%) with the afore-mentioned channel.

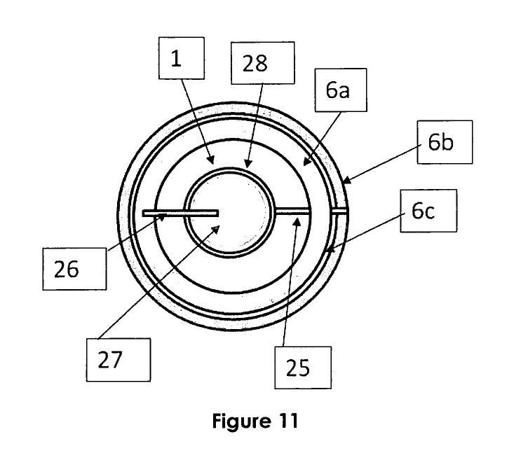

FIG. 11:

FIG. 11 shows a fuel cell system whereby a heat exchanger (6) also serves as current contact for the various electrodes of the fuel cell units. By way of example, a system is shown with only one microtubular SOFC. The electrical contact of several, preferably—but not exclusively—all solid oxide fuel cells which are enclosed by a heat exchanger and/or a system in which several fuel cells are enclosed by a heat exchanger and/or are spatially in close proximity and where said heat exchanger serves as electrical contact for all fuel cells, is possible according the present invention.

In this example (6b) shows a heat exchanger segment for the electrical contact for the outer electrode (28) and (6a) a heat exchanger segment for the electrical contact with the inner electrode (27). Contacts (25) and (26) provide the connection. (6c) describes the electrical isolation between (6b) and (6a), whereby a short circuit between the inner and outer electrode (27, 28) is prevented. By way of example, said isolation can be a thin foil made of ceramic isolator (e.g. aluminium oxide, zirconium oxide fibre, etc.), a gaseous phase, or at low temperatures (approx. up to 350° C.) a plastic coating. High-temperature steel can also be utilised, whereby said steel develops an electrically isolating layer (e.g. by aluminium oxide precipitation), based on the afore-mentioned thermal treatment in an oxidizing atmosphere or based on the operating conditions or whereby said steel is coated with ceramic. In the latter case, care must be taken to use a special construction and/or coating so that the desired contact locations are not coated by electrically isolating layers.

Said contacts (25), (26) can be achieved by using metallic or ceramic conductors, which under the respective atmosphere and operating conditions remain stable (e.g. high-temperature steels, perovskites, nickel, copper, etc.). In a system comprising more than one cell, said contacts are connected to the conductor of one or several stacks, comprising one or several fuel cells. Said conductors of the individual fuel cells are in turn connected to the respective electrodes of the fuel cell, e.g. by means of soldering, sintering, gluing or by means of mechanical contact (e.g. press contact).

Within the overall arrangement a system-internal short circuit of both fuel cell electrode types (cathode, anode) is prevented whereby contacts (26) and (25) or contact (25) and the heat exchanger segment (6a) on one hand and the contact (26) and heat exchanger segment (6b) on the other hand do not touch or whereby electrical isolation (e.g. a non-conducting layer of oxide on the surface of the electrical conductor or a ceramic isolator such as aluminium oxide) prevents the electrical contact. Within the scope of the present invention it is further possible to utilise several heat exchangers (e.g. in order to preheat the fuel separately by using the waste heat generated during the reformation or inside the afterburner and to preheat the cathode air through the exhaust gas of the fuel cell system and/or the separate tapping of electrical current of each electrode type by one heat exchanger each).

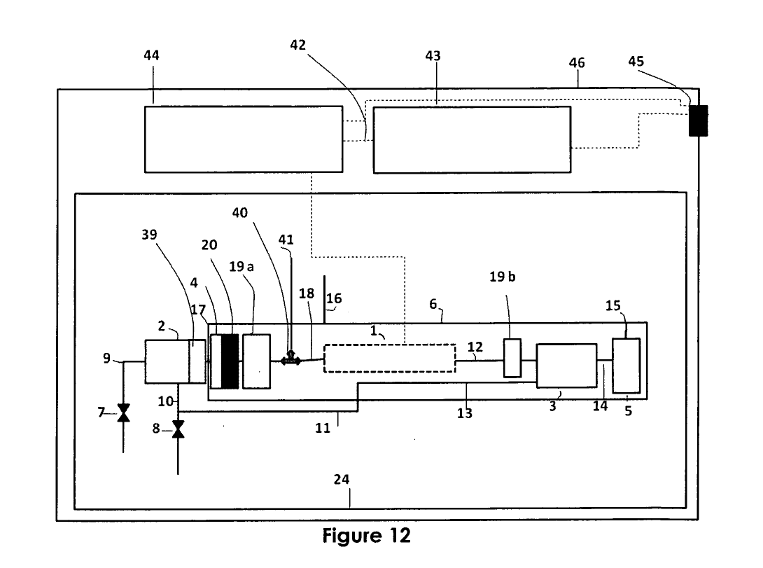

FIG. 12:

FIG. 12 describes an example that is similar to the system described in FIG. 11; however, exhibits an additional hybrid system as add-on. (42) describes the electrical contacts/lines. The fuel cell units (1) are electrically connected with a control unit (44), which if necessary, can contain a voltage converter. Said control unit (44) uses the current generated in fuel cells (1) to charge the accumulator(s) (43), which in turn is/are connected to the electrical output of the hybrid system (45). A direct contact from the fuel cells (1) via the control unit (44) to the output (45) is also possible. (46) describes the housing of the hybrid systems.

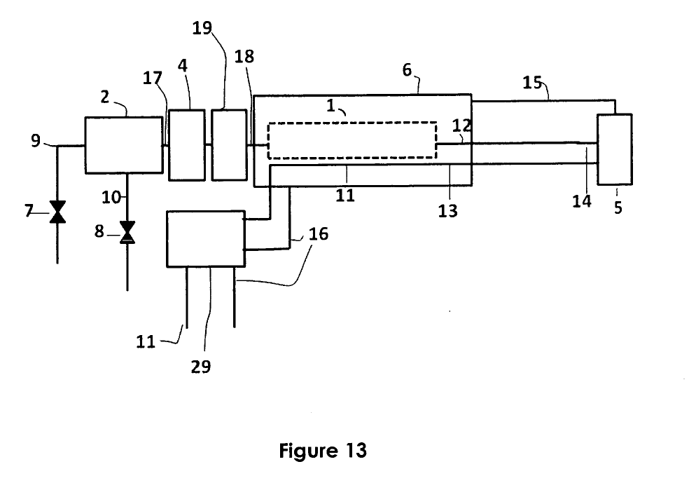

FIG. 13:

FIG. 13 describes a fuel cell system similar to FIG. 1. The jet pump/venturi nozzle (3) for the supply of the cathode air and mixing of the anode exhaust gas or cathode exhaust gas has been replaced in this case by a pump/pumps and/or fan (29), which is completely driven or supported by the exhaust gas of the system from pipe (16) (e.g. turbocharger principle). The system's exhaust gas can also enter the device (29) prior to being cooled down by the heat exchanger (6) whereby a higher flow rate and a larger kinetic energy becomes available. By way of example, a separate mixer unit for mixing the cathode exhaust gas (13) and anode exhaust gas (12) can be integrated into the system and upstream of the afterburner (5).

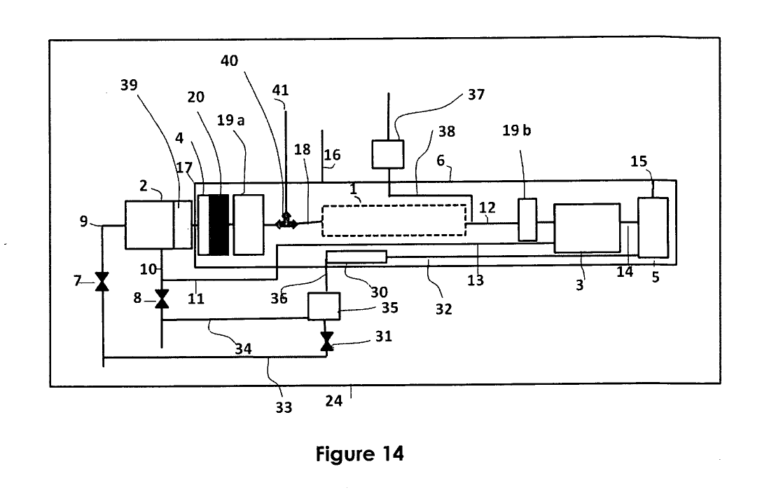

FIG. 14:

FIG. 14 describes a fuel cell system according to the present invention arranged similarly to FIG. 10. By way of example and within the scope of the present invention, an additional burner (30) is installed, whereby said burner is preferably used during the start-up phase and for the (faster) heating of the system. The fuel is supplied via pipe (33) and valve (31). A preferred variant uses pressurised fuel and whereby said fuel draws in air via a venturi nozzle and/or jet pump (35) and via pipe (34). The mixture flows via pipe (36) to the burner (30) and the hot exhaust air of the burner (30) continues via pipe (32) to the afterburner (5), and whereby said hot gas heats said afterburner directly and, if necessary, a fast ignition can occur. Subsequently, the exhaust gas exits the afterburner (5) via pipe (15) and to the heat exchanger (6). By way of example, the system also has an extra supply of coolant (e.g. air) to the cathode segment of the fuel cell unit (1) via pipe (38). By way of example, the supply is actively guaranteed via pump (37). Alternatively, the suction effect is also possible via the venturi pump and/or jet pump (3), whereby in this case the air supply is turned on or off via a valve (not shown). Coolant pipe (38) can be used to cool the system during the shutdown phase or can be activated in case of system-critical conditions. The supply of inert gas (e.g. nitrogen, noble gases) via pipe (38) in order to prevent system-critical conditions is also possible.

1. A fuel cell system comprising
at least one fuel cell unit (1) to generate electrical power and at least one component, upstream and/or downstream of said fuel cell unit in the anode flow path, said component preventing, as a reoxidation barrier, reoxidation of parts of the anode sections or of the anode sections as a whole in the case that an oxidizing gas is entering.

2. A fuel cell system comprising
at least one fuel cell unit (1) to generate electrical power,
at least one reformer (4) upstream of said fuel cell unit(s) to generate reformed fuel,
and/or at least one afterburner (5) downstream of said fuel cell unit(s),
and/or at least one heat exchanger (6) for transferring heat between the fuel cell exhaust gas(es) and the air supplied to the cathode and/or the fuel or fuel/oxidizer-mixture supplied to the system
characterized in that
one component is installed upstream of the fuel cell unit(s), said component being adapted to prevent, as a reoxidation barrier, reoxidation of the anode(s) of said fuel cell unit(s) in the case that an oxidizing gas is entering, wherein said component is preferably installed between the reformer and the fuel cell unit(s),
and/or
that a reoxidation barrier is installed downstream of the fuel cell unit(s),
and/or
that components for the removal of contaminations from the fluids are integrated,
and/or
that a soot trap, preferably a substance serving as soot trap, is installed upstream of the fuel cell unit(s) and in the anode supply region, and wherein said soot trap is preferably installed between said fuel cell unit(s) and said reformer.

3. A fuel cell system according to the preceding claim,
characterized in that
the heat exchanger (6), which is adapted for a heat transfer between fuel cell exhaust gas(es) and air supplied to the cathode and/or fuel or a fuel/oxidizer-mixture supplied to the anode(s) and/or the reformer, is located in the immediate proximity of the fuel cell unit(s) (1) and/or is arranged to enclose and/or surround the said fuel cell unit(s) (1) at least in sections, but preferably in its entirety, and/or is arranged to enclose and/or surround a reformer (4) and/or an afterburner (5) of said fuel cell system.

4. A fuel cell system according to claim 1
characterized in that
the fuel cell system furthermore comprises at least one jet pump and/or venturi nozzle (2) upstream of the fuel cell unit(s) and adapted to mix the fuel with air, steam and/or fuel cell exhaust gas(es)
and/or
that the fuel cell system further comprises at least one said jet pump and/or venturi nozzle (3) downstream of the fuel cell unit(s) and adapted to mix the anode exhaust gas with air, in particular with cathode exhaust air.

5. A fuel cell system according to claim 1 comprising at least one, preferably adjustable, valve, preferably a mechanical and/or electrical and/or pneumatic and/or hydraulic and/or electromechanical valve, adapted for the feed control of fuel and/or of air and/or steam and/or fuel cell exhaust gas(es) and/or comprising at least one check valve located at the system's exit adapted to prevent accidental inflow of ambient air into exhaust pipe(s) of the fuel cell system.

6. A fuel cell system according to claim 1 comprising tubular SOFCs as the fuel cells, preferably microtubular SOFCs which preferably have diameters of 0.1 mm-5 cm and lengths of 1 cm-40 cm, yet more preferably diameters of 0.5-5 mm and lengths between 2-8 cm,
wherein preferably at least one of the microtubular SOFC integrated in the fuel cell system functions as internal burner adapted to provide heat in the immediate proximity of the fuel cells.

7. A fuel cell system according to claim 1
wherein the reoxidation barrier contains, at least in part, nickel, carbon, iron and/or copper
and/or
wherein the reoxidation barrier can be oxidised in case of an inflowing oxidizer, in particular oxygen contained in air, in order to prevent the oxidation of the anode(s) and therefore to prevent damage to the fuel cell(s),
and/or
wherein the reoxidation barrier is constructed such that said barrier is again reducible if reducing gas re-enters said reoxidation barrier, in order to make said barrier again available as protective element.

8. A fuel cell system according to claim 1
wherein the reoxidation barrier is constructed, at least in part, as a mesh of an oxidizable component
and/or
wherein the reoxidation barrier is an oxidizable substance and/or oxidizable layer which is applied to an inert substrate.

9. A fuel cell system according to claim 2, characterized by a soot trap containing, at least partially, nickel.

10. A fuel cell system according to claim 1, wherein the reoxidation barrier is adapted to exhibit different, preferably higher temperatures than the fuel cell unit(s) and/or wherein the heat exchanger encloses or surrounds the fuel cell unit(s) and is constructed in order to tap the electrical power generated in the fuel cell unit(s).

11. A fuel cell system according to claim 1, wherein the heat exchanger is adapted to tap electrical power from the outer electrodes of microtubular SOFCs or to tap electrical power from the inner electrodes of microtubular SOFCs,
or wherein the heat exchanger comprises components that are electrically insulated from each other and are adapted to tap electrical power from the outer and from the inner electrodes of microtubular SOFCs.

12. A fuel cell system according to claim 1,
wherein several components are constructed as ceramic parts, preferably injection moulded ceramic parts,
and/or
wherein the fuel cell system is constructed as a hybrid system and comprises one or several accumulator(s) and/or one or several capacitor(s), wherein preferably the electrical power generated by the fuel cell unit(s) can be used for recharging the accumulator(s) and/or capacitor(s), wherein preferably said fuel cell unit(s) are adapted to only generate electrical power at a predetermined charge condition of the accumulators and/or capacitors,
and/or
wherein the fuel cell system is adapted to provide electrical power through said accumulator(s) and/or capacitor(s) for the supply of one or several components of the fuel cell system, in particular during the start-up-phase and the shut-down phase of said fuel cell system.

13. A fuel cell system according to the preceding claim, characterised in that the said fuel cell unit(s) exhibit(s) a voltage output of a few Volts, preferably 1 to 10 Volts, and in that a charge controller and/or voltage transformer can be utilised at this voltage for recharging the accumulator(s) and/or capacitor(s),
wherein preferably, the fuel cell unit(s) provide a voltage of less than one Volt, preferably based on a parallel connection of the fuel cells, and preferably said charge controller and/or voltage transformer is/are constructed so as to minimize the losses during the charging of the said accumulator(s) and/or capacitor(s) at a supplied voltage of less than one Volt.

14. A fuel cell system according to claim 1, characterized in that pumps, fans and/or compressors are provided in order to supply one or several reaction media, preferably air and/or fuel, to the fuel cell system, wherein preferably said pumps, fans and/or compressors are adapted to support jet pumps and/or venturi nozzles in their function.

15. A fuel cell system according to claim 1, wherein the fuel cell system is constructed in such a way that the system's exhaust gas, preferably prior to its entering into a heat exchanger integrated into the system, and/or pressurized fuel can be utilised to drive peripheral equipment such as pumps or fans which are used for the supply of air.

16. A fuel cell system according to claim 2, wherein one of or several of the heat exchanger(s) (6) is/are at least partially equipped with a catalytically active substance adapted to catalyze a chemical reaction, wherein said chemical reaction preferably generates heat or absorbs heat.

17. A fuel cell system according to claim 1, wherein the fuel cell system is arranged inside a housing, wherein said fuel cell system is inside said housing, spring mounted and/or coated with a shock-absorbing layer, so that shocks, vibrations and/or impacts on active and/or brittle materials and/or components can be avoided or at least alleviated.

18. A fuel cell system according to claim 1 wherein burners and/or reformers, that can be separately controlled and/or supplied, are integrated in particular for the start-up phase of the system and/or for temperature control.
